(19) United States
(12) Patent Application Publication
(10) Pub. No.: US 2023/0010795 A1
(43) Pub. Date: Jan. 12, 2023

(54) TRANSMISSION APPARATUS, TRANSMISSION METHOD, RECEPTION APPARATUS, RECEPTION METHOD, COMPUTER READABLE MEDIUM, AND QUANTUM-KEY DISTRIBUTION SYSTEM

(71) Applicant: Mitsubishi Electric Corporation, Tokyo (JP)

(72) Inventor: Akihiro MIZUTANI, Tokyo (JP)

(73) Assignee: Mitsubishi Electric Corporation, Tokyo (JP)

(21) Appl. No.: 17/946,505

(22) Filed: Sep. 16, 2022

Related U.S. Application Data
(63) Continuation of application No. PCT/JP2020/019183, filed on May 14, 2020.

(51) Int. Cl. H04L 9/08; H04B 10/70

(52) U.S. Cl. CPC H04L 9/0858; H04B 10/70

(57) ABSTRACT

A random-number generation unit (301) generates a random bit string. A light-source control unit (302) generates as transmission signal, using a light source, light pulses each of which corresponds to each bit value in the random bit string generated by the random-number generation unit, and emits the light pulses to a reception apparatus. A transmission-side information acquisition unit (305) acquires from a light-source measurement apparatus which has measured the light pulses and has estimated a physical characteristic, the physical characteristic, and acquires from the reception apparatus, a signal reception result of the transmission signal. A transmission-side information generation unit (303) generates a secret key, using the random bit string, the physical characteristic, and the signal reception result.

### CROSS REFERENCE TO RELATED APPLICATIONS

This application is a Continuation of PCT International Application PCT/JP2020/019183, filed on May 14, 2020, which is hereby expressly incorporated by reference into the present application.

### TECHNICAL FIELD

The present disclosure relates to a transmission apparatus, a transmission method, a transmission program, a reception apparatus, a reception method, a reception program, and a quantum-key distribution system.

### BACKGROUND ART

Quantum-key distribution is an encryption technique for distributing a secret key being secure in terms of information theory between a transmission apparatus and a reception apparatus by transmitting and receiving light on a quantum communication path and by transmitting and receiving data on a public communication path, using the transmission apparatus and the reception apparatus. By performing encryption communication with use of the secret key distributed in this quantum-key distribution, absolutely-secure communication is possible, which never leak information for eternity even to an eavesdropper who has unlimited calculation capability.

In order to generate the secure secret key necessary to realize such quantum-key distribution, the transmission apparatus and the reception apparatus are necessary to operate in a way required in security proof which proves security of the secret key of the quantum-key distribution. Hereinafter, this requirement is referred to as requirement for security proof.

The requirement for the security proof needs to correspond to physical characteristics of the actual transmission apparatus and the actual reception apparatus. That is because the security of the actual secret key to be distributed in the quantum-key distribution is not secured when the requirement for the security proof and the physical characteristics of the actual transmission apparatus and the actual reception apparatus differ from each other.

However, in actual quantum-key distribution, there is a problem that the requirement for the security proof and the physical characteristics of the actual transmission apparatus and the actual reception apparatus differ from each other.

As a method of preventing difference between the requirement for the security proof and the physical characteristic of the actual transmission apparatus and the actual reception apparatus, a method has been considered of measuring the physical characteristic of the transmission apparatus and reception apparatus before performing the quantum-key distribution, and performing the quantum-key distribution which proves the security of the secret key based on the measurement result.

Patent Literature 1 focuses on the transmission apparatus and suggests a method that a measurement apparatus estimates number-of-photons statistics of light emitted, for the transmission apparatus which emits light pulses.

The requirement for the security proof in this literature requires that each of four types of light pulses emitted is in “a polarization state in a relation of 90-degrees rotational symmetry”, however, the number-of-photons statistics of the light pulses emitted by the transmission apparatus are not required to be known in advance.

That is, this literature indicates that as long as the transmission apparatus which emits the four types of light pulses whose polarization state is symmetrical is used, secure quantum-key distribution can be realized by estimating the number-of-photons statistics with use of the measurement apparatus even if the number-of-photons statistics are not known in advance.

### CITATION LIST

### Non-Patent Literature

Non-Patent Literature 1: Masahiro Kumazawa, Toshihiko Sasaki, Masato Koashi, “Rigorous characterization method for photon-number statistics.”, Optics Express, 18 Feb. 2019, Vol. 27, No. 4, p. 5297-5313

### SUMMARY OF INVENTION

### Technical Problem

The security proof in the quantum-key distribution described in Non-Patent Literature 1 requires that the light emitted by the transmission apparatus is the four types of light pulses whose polarization state is symmetrical.

However, with an actual transmission apparatus, emitting the light pulses each having polarization with exactly 90 degrees rotation cannot be technically realized. Thus, the actual transmission apparatus cannot satisfy the requirement for a physical characteristic of the light pulses which is “a polarization state in a relation of 90-degrees rotational symmetry” in Non-Patent Literature 1. That is, the method described in Non-Patent Literature 1 has a problem that the requirement for the security proof and the characteristic of the actual apparatus differ from each other.

The present disclosure mainly aims to realize quantum-key distribution which generates a secure secret key between a transmission apparatus and a reception apparatus, without requiring a physical characteristic of light emitted by the transmission apparatus.

### Solution to Problem

A transmission apparatus according to the present disclosure includes:

a random-number generation unit to generate a random bit string;

a light-source control unit to generate as transmission signal, using a light source, light pulses each of which corresponds to each bit value in the random bit string generated by the random-number generation unit, and emit the light pulses to a reception apparatus;

a transmission-side information acquisition unit to acquire from a light-source measurement apparatus which has measured the light pulses and has estimated number-of-photons statistics, the number-of-photons statistics, and acquire from the reception apparatus, a signal reception result of the transmission signal; and

a transmission-side information generation unit to generate a secret key, using the random bit string, the number-of-photons statistics, and the signal reception result.

### Advantageous Effects of Invention

According to the present disclosure, it is possible to realize quantum-key distribution which generates a secure secret key between a transmission apparatus and a reception apparatus, without requiring a physical characteristic of light emitted by the transmission apparatus, since a transmission-side information acquisition unit acquires number-of-photons statistics which are a physical characteristic enough for security proof of a quantum key, from a light-source measurement apparatus which has measured light pulses and estimated the number-of-photons statistics.

### BRIEF DESCRIPTION OF DRAWINGS

FIG. 1 is a diagram illustrating a system configuration example of a quantum-key distribution system 100 according to a first embodiment.

FIG. 2 is a diagram illustrating a transmission apparatus 300 and a reception apparatus 400 in the quantum-key distribution system 100 according to the first embodiment.

FIG. 3 is a diagram illustrating a hardware configuration example of the transmission apparatus 300 according to the first embodiment.

FIG. 4 is a diagram illustrating a hardware configuration example of the reception apparatus 400 according to the first embodiment.

FIG. 5 is a diagram illustrating examples of processing operations of a light-source measurement apparatus 200 according to the first embodiment.

FIG. 6 is a diagram illustrating examples of processing operations of the transmission apparatus 300 according to the first embodiment.

FIG. 7 is a diagram illustrating examples of processing operations of the reception apparatus 400 according to the first embodiment.

FIG. 8 is a diagram illustrating a correspondence relation between the detected numbers of photons and success/failure of signal detection based on the “rules of signal detection” according to the first embodiment.

### DESCRIPTION OF EMBODIMENTS

Hereinafter, an embodiment of the present disclosure will be described with reference to the drawings. In the following description of the embodiment and the drawings, parts assigned the same reference numerals indicate the same parts or corresponding parts.

Note that, the present disclosure is not limited to the embodiment described below, and various modifications can be made as necessary. For example, the embodiment described below may be partially implemented.

### First Embodiment

### *** Description of Configuration ***

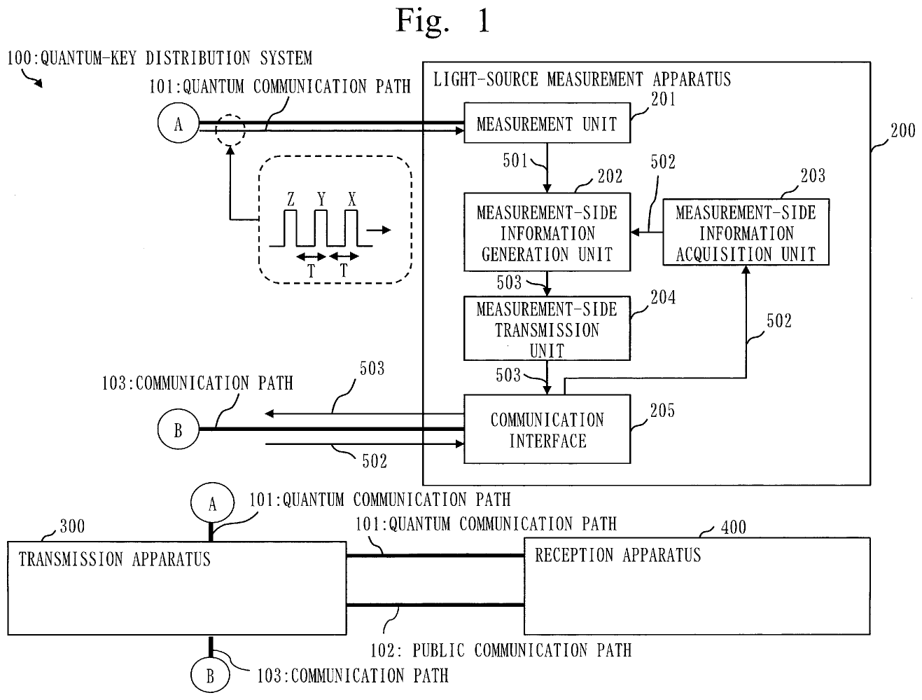

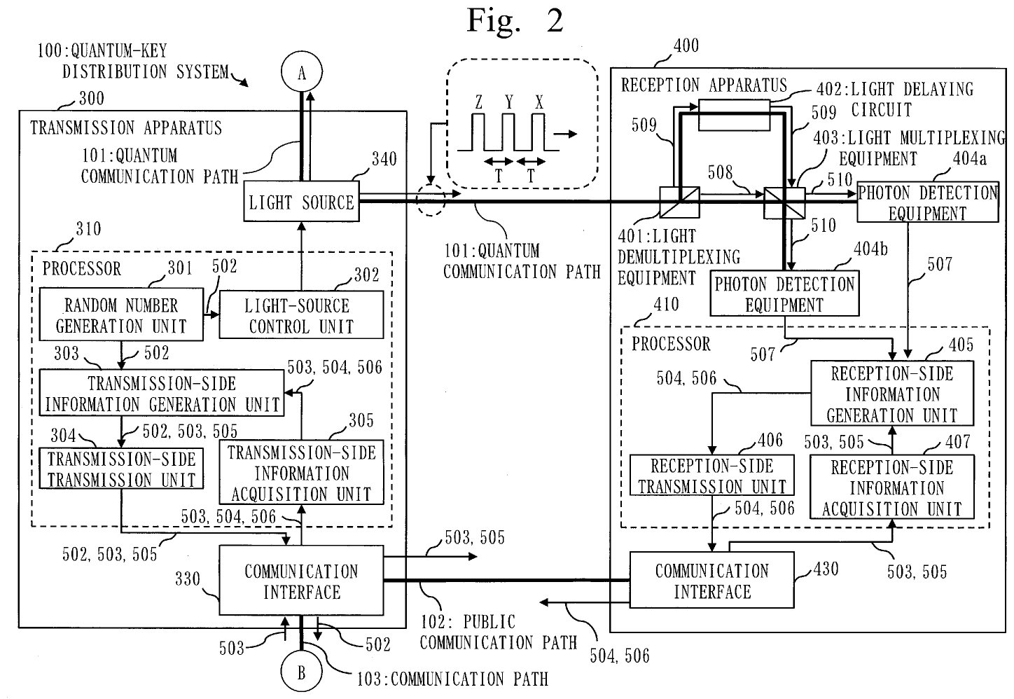

With use of FIGS. 1 and 2, a system configuration example of a quantum-key distribution system 100 according to the present embodiment will be described.

FIGS. 1 and 2 illustrate system configuration examples of the quantum-key distribution system 100 according to the present embodiment.

The quantum-key distribution system 100 includes a light-source measurement apparatus 200, a transmission apparatus 300, and a reception apparatus 400 as illustrated in FIGS. 1 and 2. Further, the quantum-key distribution system 100 includes a quantum communication path 101 and a public communication path 102 as communication paths which connect the transmission apparatus 300 and the reception apparatus 400 with each other. Further, the quantum communication path 101 and a communication path 103 are included as communication paths which connect the light-source measurement apparatus 200 and the transmission apparatus 300 with each other.

The light-source measurement apparatus 200 illustrated in FIG. 1 measures light pulses emitted by the transmission apparatus 300, estimates number-of-photons statistics regarding zero photon, one photon, two photons, and three photons in the light pulses, as a physical characteristic, and outputs the number-of-photons statistics to the transmission apparatus 300.

The zero photon indicates that no photon exists in the light pulses.

The one photon indicates that one photon exists in the light pulses.

The two photons indicate that two photons exist in the light pulses.

The three photons indicate that three photons exist in the light pulses.

The number-of-photons statistics are statistics obtained by estimating a probability of the number of photons existing in the light pulses emitted by the transmission apparatus 300, from a measurement result 501 relating to the number of photons existing in the light pulses emitted by the transmission apparatus 300.

The transmission apparatus 300 illustrated in FIG. 2 generates and emits the light pulses as a transmission signal.

Note that, an operation procedure of the transmission apparatus 300 is equivalent to a transmission method. Further, a program which realizes operations of the transmission apparatus 300 is equivalent to a transmission program.

The light pulses emitted by the transmission apparatus 300 enter the reception apparatus 400 illustrated in FIG. 2, and the reception apparatus 400 receives the transmission signal.

Note that, an operation procedure of the reception apparatus 400 is equivalent to a reception method. Further, a program which realizes operations of the reception apparatus 400 is equivalent to a reception program.

The quantum communication paths 101 illustrated in FIG. 2 are configured with communication paths which have directivity to deliver the light pulses emitted by the transmission apparatus 300. As a specific example, in a case where the present embodiment is implemented on the ground, the quantum communication paths 101 are configured with optical fibers.

The public communication path 102 illustrated in FIG. 2 is a communication path which delivers data between the transmission apparatus 300 and the reception apparatus 400. The public communication path 102 may be any means for delivering a digital signal, and is, as a specific example, a communication path for Ethernet (registered trademark).

The communication path 103 illustrated in FIG. 2 is a communication path which delivers data between the light-source measurement apparatus 200 and the transmission apparatus 300. A specific example is a communication path conforming to a communication standard such as Ethernet (registered trademark), or a communication path dedicated to equipment to be connected.

With use of FIGS. 1 and 2, functional configurations of the light-source measurement apparatus 200, the transmission apparatus 300, and the reception apparatus 400 will be described in order.

The light-source measurement apparatus 200 illustrated in FIG. 1 includes a measurement unit 201, a measurement-side information generation unit 202, a measurement-side information acquisition unit 203, a measurement-side transmission unit 204, and a communication interface 205.

The measurement unit 201 illustrated in FIG. 1 measures the light pulses emitted by the transmission apparatus 300. More specifically, the measurement unit 201 treats as input, the light pulses emitted by the transmission apparatus 300 and measures as to whether or not the photon has existed in the light pulses. Then, the measurement unit 201 outputs to the measurement-side information generation unit 202 as the number-of-photons-related measurement result 501, information as to whether or not the photon has existed in the light pulses.

The measurement-side information acquisition unit 203 illustrated in FIG. 1 acquires from the transmission apparatus 300 through the communication path 103, a random bit string 502 input by a light-source control unit 302 from a random-number generation unit 301 when a light source 340 of the transmission apparatus 300 emits the light pulses. Then, the measurement-side information acquisition unit 203 stores the random bit string 502 in a storage unit. Then, the measurement-side information acquisition unit 203 outputs the random bit string 502 to the measurement-side information generation unit 202.

Details of the transmission apparatus 300, the light-source control unit 302, the light source 340, and the random bit string 502 will be described later.

The measurement-side information generation unit 202 illustrated in FIG. 1 acquires the number-of-photons-related measurement result 501 output by the measurement unit 201, and the random bit string 502 acquired by the measurement-side information acquisition unit 203. Then, the measurement-side information generation unit 202 estimates statistics data D503=(D1, D2, D3, D4, and D5) based on the number-of-photons-related measurement result 501 and the random bit string 502, stores the statistics data D503 in the storage unit, and outputs the statistics data D503 to the measurement-side transmission unit 204. The statistics data D503 is the number-of-photons statistics regarding the zero photon, the one photon, the two photons, and the three photons, and are specifically data (1) to (5) below.

### “Statistics Data D503”

(1) D1: an upper limit value PD1U and a lower limit value PD1L of a probability that one light pulse emitted when a bit value is “0” is empty, at a time when the light-source control unit 302 of the transmission apparatus 300 acquires the random bit string 502 from the random-number generation unit 301 and causes the light source 340 to emit a light pulse corresponding to each bit value in the random bit string 502 three times in a row at a time interval T.
(2) D2: an upper limit value PD2U and a lower limit value PD2L of a probability that one light pulse emitted when a bit value is “1” is empty, at a time when the light-source control unit 302 of the transmission apparatus 300 acquires the random bit string 502 from the random-number generation unit 301 and causes the light source 340 to emit a light pulse corresponding to each bit value in the random bit string 502 three times in a row at the time interval T.
(3) D3: An upper limit value PD3 of a probability that one or more photons in total exist in three consecutive light pulses that the light-source control unit 302 causes the light source 340 to emit
(4) D4: An upper limit value PD4 of a probability that two or more photons in total exist in three consecutive light pulses that the light-source control unit 302 causes the light source 340 to emit
(5) D5: An upper limit value PD5 of a probability that three or more photons in total exist in three consecutive light pulses that the light-source control unit 302 causes the light source 340 to emit

Note that, that the light pulse is empty means that no photon exists in the light pulse and there is zero photon.

The three consecutive light pulses are three light pulses when the light-source control unit 302 of the transmission apparatus 300 acquires the random bit string 502 from the random-number generation unit 301 and causes the light source 340 to emit the light pulse corresponding to each bit value in the random bit string 502 at the time interval T in a row.

The measurement-side transmission unit 204 illustrated in FIG. 1 acquires the statistics data D503 stored in the storage unit by the measurement-side information generation unit 202. Then, the measurement-side transmission unit 204 transmits to the transmission apparatus 300, the statistics data D503 acquired from the storage unit through the communication path 103.

The communication interface 205 illustrated in FIG. 1 executes with the transmission apparatus 300 through the communication path 103, communication processes of pieces of information regarding the random bit string 502 and the statistics data D503.

The transmission apparatus 300 illustrated in FIG. 2 includes the random-number generation unit 301, the light-source control unit 302, a transmission-side information generation unit 303, a transmission-side transmission unit 304, a transmission-side information acquisition unit 305, a communication interface 330, and the light source 340.

The random-number generation unit 301 illustrated in FIG. 2 generates a random bit of 0 or 1 selected randomly and generates three-bits random bit strings 502 of eight types from three random bits.

Specific examples of the three-bits random bit strings 502 of eight types are as follows.

000

001

010

011

100

101

110

111

Hereinafter, for convenience, bits from a left end to a right end of the random bit string 502 are referred to as a first bit, a second bit, and a third bit in order.

Then, the random-number generation unit 301 outputs the random bit string 502 to the light-source control unit 302 and the transmission-side information generation unit 303.

The light-source control unit 302 illustrated in FIG. 2 generates as the transmission signal, using the light source 340, the light pulse corresponding to each bit value in the random bit string 502 generated by the random-number generation unit 301, and emits the light pulse to the light-source measurement apparatus 200 and the reception apparatus 400.

The light source 340 illustrated in FIG. 2 is controlled by the light-source control unit 302, and generates and emits the light pulse to the light-source measurement apparatus 200 and the reception apparatus 400 through the quantum communication paths 101.

More specifically, the light-source control unit 302 acquires the random bit string 502 from the random-number generation unit 301 and causes the light source 340 to generate the light pulse corresponding to each bit value in the random bit string 502. Further, the light-source control unit 302 generates as one block of light pulse string, the consecutive light pulses emitted three times in a row at the time interval T, using the light source 340, and emits the light pulse string to the light-source measurement apparatus 200 and the reception apparatus 400. This light pulse string is the same as the above-described three consecutive light pulses, and hereinafter, this light pulse string is referred to as three consecutive light pulses.

Corresponding to each bit value in the random bit string 502 means that one independent light pulse is generated corresponding to one bit value.

Further, the light pulse that the light-source control unit 302 causes the light source 340 to emit is light pulse whose physical characteristic such as polarization or a phase may vary depending on the bit value of “0” or “1”. That is, the light pulse when the bit value is “0” and the light pulse when the bit value is “1” may be different from each other in the physical characteristic such as the polarization or the phase.

Then, the light-source control unit 302 transmits as the transmission signal, using the light source 340, the three consecutive light pulses to the light-source measurement apparatus 200 and the reception apparatus 400 through the quantum communication paths 101.

A specific example of the light pulse according to the present embodiment is a light pulse which is a plane wave and has π as a phase difference between the light pulse generated when the bit value is “0” and the light pulse generated when the bit value is “1”.

FIG. 2 illustrates that the three consecutive light pulses which are a primary light pulse X corresponding to the first bit, a secondary light pulse Y corresponding to the second bit, and a tertiary light pulse Z corresponding to the third bit are transmitted from the light source 340 to the reception apparatus 400 at the time interval T in a row.

No matter whether the bit value is “0” or “1”, the light pulse is emitted from the transmission apparatus 300. The light pulse generated when the bit value is “0” and the light pulse generated when the bit value is “1” may be different from each other in the physical characteristic such as the polarization or the phase.

The light source 340 generates the light pulse having a probability that a probability of existence of one or more photons in one light pulse is sufficiently smaller than 1.0. As a specific example, the light source 340 generates a light pulse whose probability that only one photon exists in one light pulse is 0.01.

However, in the quantum-key distribution system 100 according to the present embodiment, a probability of the number of photons existing in the light pulse generated by the light source 340 does not need to be known in advance, and it is sufficient if the probability is estimated as the number-of-photons statistics by the light-source measurement apparatus 200.

Specifically, the light-source measurement apparatus 200 measures as to whether or not the photon exists in the light pulse transmitted by the transmission apparatus 300, and estimates the statistics data D503 which is the number-of-photons statistics, from the number-of-photons-related measurement result 501. Then, the transmission apparatus 300 and the reception apparatus 400 use the statistics data D503 estimated by the light-source measurement apparatus 200, which enables the transmission apparatus 300 and the reception apparatus 400 to generate a secure secret key regardless of the physical characteristic of the light pulse.

The transmission-side information generation unit 303 illustrated in FIG. 2 generates a secret key, using the random bit string 502 generated by the random-number generation unit 301, the statistics data D503 estimated by the light-source measurement apparatus 200, and a signal reception result 504 and reception-side error correction information 506 which have been generated by the reception apparatus 400.

More specifically, the transmission-side information generation unit 303 acquires the random bit string 502 from the random-number generation unit 301, acquires the statistics data D503, the signal reception result 504, and the reception-side error correction information 506 which have been stored in the storage unit by the transmission-side information acquisition unit 305, and stores these in the storage unit. Note that, the signal reception result 504 includes success/failure of signal detection and a multiplexed pulse number j. Details of the reception-side error correction information 506, the signal reception result 504, the success/failure of the signal detection, and the multiplexed pulse number j will be described later.

Further, the transmission-side information generation unit 303 generates a transmission-side bit value, using the random bit string 502 and the signal reception result 504 according to following rules (hereinafter, referred to as “generation rules of a transmission-side bit string”).

“Generation Rules of a Transmission-Side Bit String”

When the transmission-side information generation unit 303 refers to the multiplexed pulse number j and finds that the j-th (j=1 or 2) bit value and the j+1-th (j+1=2 or 3) bit value in the random bit string 502 are the same values, the transmission-side information generation unit 303 generates a transmission-side bit value “0”. On the other hand, when the transmission-side information generation unit 303 refers to the multiplexed pulse number j and finds that the j-th bit value and the j+1-th bit value in the random bit string 502 are not the same values, the transmission-side information generation unit 303 generates a transmission-side bit value “1”.

Specifically, the generation rules are as follows.

When (the j-th bit value in the random bit string 502, the j+1-th bit value in the random bit string 502)=(0, 0) or (1, 1), the transmission-side bit value=0.

When (the j-th bit value in the random bit string 502, the j+1-th bit value in the random bit string 502)=(0, 1) or (1, 0), a transmission-side bit value=1.

Then, after transmitting the transmission signal a plurality of times, the transmission-side information generation unit 303 generates a transmission-side bit string by concatenating in a time series manner, the transmission-side bit values generated according to “generation rules of a transmission-side bit string”.

Further, the transmission-side information generation unit 303 generates transmission-side error correction information 505 which is used for error correction of the reception-side bit string.

Further, the transmission-side information generation unit 303 outputs the transmission-side error correction information 505, the statistics data D503, and the random bit string 502 to the transmission-side transmission unit 304.

Further, the transmission-side information generation unit 303 estimates a bit error rate, using the reception-side error correction information 506 which is information for estimating the bit error rate between the reception-side bit string generated by the reception apparatus 400 and the transmission-side bit string.

Then, the transmission-side information generation unit 303 generates the secret key by performing privacy amplification on the transmission-side bit string with use of the statistics data D503. Details of the privacy amplification will be described later.

Specific examples of the transmission-side error correction information 505 are an estimation result of the bit error rate between the transmission-side bit string and the reception-side bit string, and a syndrome of an LDPC (LOW DENSITY PARITY CHECK) code. Hereinafter, the estimation result of the bit error rate between the transmission-side bit string and the reception-side bit string is written as E.

The transmission-side transmission unit 304 illustrated in FIG. 2 acquires the transmission-side error correction information 505, the statistics data D503, and the random bit string 502 from the transmission-side information generation unit 303, and stores these in the storage unit.

Further, the transmission-side transmission unit 304 transmits the transmission-side error correction information 505 and the statistics data D503 to the reception apparatus 400 through the public communication path 102 via the communication interface 330.

Further, the transmission-side transmission unit 304 transmits the random bit string 502 to the light-source measurement apparatus 200 through the communication path 103 via the communication interface 330.

The transmission-side information acquisition unit 305 illustrated in FIG. 2 acquires the statistics data D503 which is the number-of-photons statistics regarding the zero photon, the one photon, the two photons, and the three photons in the light pulses, from the light-source measurement apparatus 200 through the communication path 103 via the communication interface 330, and stores the statistics data D503 in the storage unit.

Further, the transmission-side information acquisition unit 305 acquires the signal reception result 504 for the transmission signal transmitted by the transmission apparatus 300, and the reception-side error correction information 506 which is information for estimating the bit error rate between the reception-side bit string and the transmission-side bit string, from the reception apparatus 400 through the public communication path 102 via the communication interface 330, and stores these in the storage unit.

Then, the transmission-side information acquisition unit 305 outputs the statistics data D503, the signal reception result 504, and the reception-side error correction information 506 to the transmission-side information generation unit 303.

The communication interface 330 illustrated in FIG. 2 executes with the reception apparatus 400 through the public communication path 102, communication processes of pieces of information regarding the statistics data D503, the signal reception result 504, the transmission-side error correction information 505, and the reception-side error correction information 506.

Further, the communication interface 330 executes with the light-source measurement apparatus 200 through the communication path 103, communication processes of pieces of information regarding the statistics data D503 and the random bit string 502.

The reception apparatus 400 illustrated in FIG. 2 includes light demultiplexing equipment 401, a light delaying circuit 402, light multiplexing equipment 403, photon detection equipment 404a, photon detection equipment 404b, a reception-side information generation unit 405, a reception-side transmission unit 406, a reception-side information acquisition unit 407, and a communication interface 430.

The light demultiplexing equipment 401 illustrated in FIG. 2 demultiplexes the light pulse which has entered from the transmission apparatus 300 through the quantum communication path 101, into a first light pulse 508 and a second light pulse 509 into which energy has been equally divided. Then, the light demultiplexing equipment 401 emits the first light pulse 508 toward the light multiplexing equipment 403 and the second light pulse 509 toward the light delaying circuit 402. The light demultiplexing equipment 401 is configured with, as specific examples, a beam splitter, a light coupler, and a directional coupler.

The light delaying circuit 402 illustrated in FIG. 2 delays delivery of the second light pulse 509 which enters from the light demultiplexing equipment 401. More specifically, the light delaying circuit 402 has been set to add delay time equal to the time interval T at which the light pulse is generated in the transmission apparatus 300, to the first light pulse 508 emitted from the light demultiplexing equipment 401 and the second light pulse 509 emitted from the light demultiplexing equipment 401.

The second light pulse 509 emitted from the light demultiplexing equipment 401 enters one of two entrance portions of the light multiplexing equipment 403 after going through the light delaying circuit 402. Further, the first light pulse 508 emitted from the light demultiplexing equipment 401 enters the other one of the two entrance portions of the light multiplexing equipment 403.

The light multiplexing equipment 403 illustrated in FIG. 2 generates a multiplexed pulse 510 by multiplexing the second light pulse 509 which has entered from the light delaying circuit 402 and the first light pulse 508 which has entered from the light demultiplexing equipment 401. Then, the light multiplexing equipment 403 emits the multiplexed pulse 510 to the photon detection equipment 404a and the photon detection equipment 404b.

More specifically, the light multiplexing equipment 403 generates the multiplexed pulse 510 by multiplexing the second light pulse 509 which has entered from the light delaying circuit 402 and the first light pulse 508 which has entered from the light demultiplexing equipment 401. Then, the light multiplexing equipment 403 emits the multiplexed pulse 510 from one of two emittance portions to the photon detection equipment 404a.

Further, the light multiplexing equipment 403, after shifting the phase of the first light pulse 508 by 7C, generates the multiplexed pulse 510 by multiplexing the second light pulse 509 which has entered from the light delaying circuit 402 and the first light pulse 508 which has entered from the light demultiplexing equipment 401. Then, the light multiplexing equipment 403 emits the multiplexed pulse 510 from the other one of the two emittance portions to the photon detection equipment 404b.

With the arrangement described above of the light demultiplexing equipment 401, the light delaying circuit 402, and the light multiplexing equipment 403, the multiplexed pulse 510 including following four light pulses is emitted from the light multiplexing equipment 403 when the three consecutive light pulses enter.

1. a light pulse (hereinafter, referred to as a multiplexed pulse P) obtained by multiplexing the secondary light pulse Y of the first light pulse 508 and the primary light pulse X of the second light pulse 509 by a superposition principle

2. a light pulse (hereinafter, referred to as a multiplexed pulse Q) obtained by multiplexing the tertiary light pulse Z of the first light pulse 508 and the secondary light pulse Y of the second light pulse 509 by a superposition principle

3. the primary light pulse X of the first light pulse 508

4. the tertiary light pulse Z of the second light pulse 509

Then, the light multiplexing equipment 403 generates the multiplexed pulses 510 to be emitted from the two emittance portions of the light multiplexing equipment 403, in different methods depending on each emittance portion, and consequently, there arises a difference between a probability that the photon is detected in the photon detection equipment 404a and a probability that the photon is detected in the photon detection equipment 404b.

Below, with use of a specific example, a mechanism will be described in which there arises the difference between the probability that the photon is detected in the photon detection equipment 404a and the probability that the photon is detected in the photon detection equipment 404b.

As the specific example, it is assumed that the primary light pulse X, the secondary light pulse Y, and the tertiary light pulse Z are emitted as the three consecutive light pulses corresponding to the random bit string 502 “000”. Then, it is assumed that the light pulses each corresponding to each bit value in the random bit string 502 are plane waves having the same strength, the same phases, and the same pulse width. That is, the primary light pulse X, the secondary light pulse Y, and the tertiary light pulse Z are the plane waves having the same strength, the same phases, and the same pulse width.

In this case, the multiplexed pulse 510 which enters the photon detection equipment 404a includes the multiplexed pulse P whose strength has been strengthened by superimposition of the secondary light pulse Y of the first light pulse 508 and the primary light pulse X of the second light pulse 509 at the same phase. Further, the multiplexed pulse 510 which enters the photon detection equipment 404a includes the multiplexed pulse Q whose strength has been strengthened by superimposition of the tertiary light pulse Z of the first light pulse 508 and the secondary light pulse Y of the second light pulse 509 at the same phase.

On the other hand, the multiplexed pulse 510 which enters the photon detection equipment 404b includes the multiplexed pulse P in which the secondary light pulse Y of the first light pulse 508 and the primary light pulse X of the second light pulse 509 have canceled each other out by being superposed at an opposed phase. Further, the multiplexed pulse 510 which enters the photon detection equipment 404b includes the multiplexed pulse Q in which the tertiary light pulse Z of the first light pulse 508 and the secondary light pulse Y of the second light pulse 509 have canceled each other out by being superposed at an opposed phase.

The stronger the strength of the entering light is, the higher the probabilities that the photon detection equipment 404a and the photon detection equipment 404b detect the photons are. Therefore, the probability of detecting the photon by the photon detection equipment 404a where the multiplexed pulse 510 enters which includes the multiplexed pulse P and the multiplexed pulse Q each of which has strengthened strength, is higher than the probability of detecting the photon by the photon detection equipment 404b where the multiplexed pulse 510 enters which includes the multiplexed pulse P and the multiplexed pulse Q in both of which light pulses have been canceled out.

Further, as another specific example, it is assumed that the primary light pulse X, the secondary light pulse Y, and the tertiary light pulse Z are emitted as the three consecutive light pulses each corresponding to the random bit string 502 “010”. Then, it is assumed that the light pulses corresponding to each bit value in the random bit string 502 are plane waves having the same strength and the same pulse width. Further, it is assumed that a phase difference between a light pulse corresponding to a bit value of “0” and a light pulse corresponding to a bit value of “1” is π. That is, the primary light pulse X and the tertiary light pulse Z are plane waves having the same strength, the same phases, and the same pulse width. Further, the secondary light pulse Y is a plane wave having the same strength and the same pulse width as the primary light pulse X and the tertiary light pulse Z and having a phase shifted by 7C from the primary light pulse X and the tertiary light pulse Z.

In this case, the multiplexed pulse 510 which enters the photon detection equipment 404a includes the multiplexed pulse P in which the secondary light pulse Y of the first light pulse 508 and the primary light pulse X of the second light pulse 509 have canceled each other out by being superposed at the opposed phase. Further, the multiplexed pulse 510 which enters the photon detection equipment 404a includes the multiplexed pulse Q in which the tertiary light pulse Z of the first light pulse 508 and the secondary light pulse Y of the second light pulse 509 have canceled each other out by being superposed at the opposed phase.

On the other hand, the multiplexed pulse 510 which enters the photon detection equipment 404b includes the multiplexed pulse P whose strength has been strengthen by superimposition of the secondary light pulse Y of the first light pulse 508 and the primary light pulse X of the second light pulse 509 at the same phase. Further, the multiplexed pulse 510 which enters the photon detection equipment 404b includes the multiplexed pulse Q whose strength has been strengthen by superimposition of the tertiary light pulse Z of the first light pulse 508 and the secondary light pulse Y of the second light pulse 509 at the same phase.

The stronger the strength of the entering light is, the higher the probabilities that the photon detection equipment 404a and the photon detection equipment 404b detect the photons are. Therefore, the probability of detecting the photon by the photon detection equipment 404a where the multiplexed pulse 510 enters which includes the multiplexed pulse P and the multiplexed pulse Q in both of which light pulses have been canceled out, is lower than the probability of detecting the photon by the photon detection equipment 404b where the multiplexed pulse 510 enters which includes the multiplexed pulse P and the multiplexed pulse Q each of which has the strengthened strength.

As described above, the probability of detecting the photon changes in each of the photon detection equipment 404a and the photon detection equipment 404b, depending on the bit values in the random bit string 502.

The photon detection equipment 404a and the photon detection equipment 404b illustrated in FIG. 2 detect the numbers of photons existing in the multiplexed pulses 510 which have been generated by the light multiplexing equipment 403 and have entered from the light multiplexing equipment 403, the multiplexed pulses 510 having been generated from the three consecutive light pulses which have been emitted from the transmission apparatus 300 and have entered the reception apparatus 400. Further, the photon detection equipment 404a and the photon detection equipment 404b detect the numbers of photons in the multiplexed pulses 510, identifying which of zero, one, and two or more the numbers of photons are. Further, the photon detection equipment 404a and the photon detection equipment 404b detect which of the light pulses the photon exists in, identifying the multiplexed pulse P and the multiplexed pulse Q included in the multiplexed pulse 510, the primary light pulse X of the first light pulse 508, and the tertiary light pulse Z of the second light pulse 509. Then, the photon detection equipment 404a and the photon detection equipment 404b output the detected numbers of photons to the reception-side information generation unit 405 as number-of-photons detection results 507.

The reception-side information generation unit 405 illustrated in FIG. 2 acquires the number-of-photons detection results 507 from the photon detection equipment 404a and the photon detection equipment 404b and stores the number-of-photons detection results 507 in the storage unit. Then, the reception-side information generation unit 405 decides the success/failure of the signal detection, using the number-of-photons detection results 507, according to following rules (hereinafter, referred to as “rules of signal detection”).

“Rules of Signal Detection”

(a) The signal detection is “success”, when a total of the number of photons detected in the multiplexed pulse P and the number of photons detected in the multiplexed pulse Q is one in measurement which uses the photon detection equipment 404a and the photon detection equipment 404b for entrance of the three consecutive light pulses of the primary light pulse X, the secondary light pulse Y, and the tertiary light pulse Z emitted from the transmission apparatus 300.
(i) The signal detection is “failure”, when the detection result other than (a) described above is obtained.

That is, cases of “failure” are following cases.

1. A case where a total of the number of photons detected in the multiplexed pulse P and the number of photons detected in the multiplexed pulse Q is zero in measurement which uses the photon detection equipment 404a and the photon detection equipment 404b, for entrance of the three consecutive light pulses of the primary light pulse X, the secondary light pulse Y, and the tertiary light pulse Z emitted from the transmission apparatus 300.

2. A case where two or more photons have been detected in at least one of the multiplexed pulse P and the multiplexed pulse Q in measurement which uses the photon detection equipment 404a and the photon detection equipment 404b, for entrance of the three consecutive light pulses of the primary light pulse X, the secondary light pulse Y, and the tertiary light pulse Z emitted from the transmission apparatus 300.

3. A case where one photon has been detected in each of the multiplexed pulse P and the multiplexed pulse Q in measurement which uses the photon detection equipment 404a and the photon detection equipment 404b, for entrance of the three consecutive light pulses of the primary light pulse X, the secondary light pulse Y, and the tertiary light pulse Z emitted from the transmission apparatus 300.

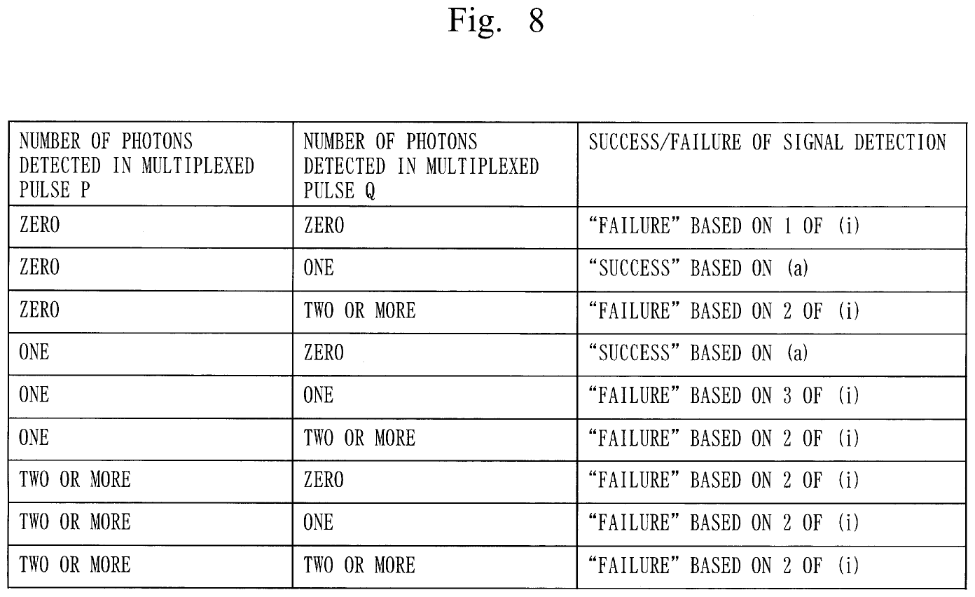

FIG. 8 illustrates correspondence relations between the detected numbers of photons and the success/failure of the signal detection based on “rules of signal detection” described above.

FIG. 8 illustrates the numbers of photons detected in the multiplexed pulse P, the numbers of photons detected in the multiplexed pulse Q, and the success/failure of the signal detection in order from a column at a left end to a column at a right end.

More specifically, FIG. 8 illustrates that when the number of photons detected in the multiplexed pulse P is zero and the number of photons detected in the multiplexed pulse Q is zero, the signal detection is “failure” based on 1 of (i) in “rules of signal detection”.

Further, FIG. 8 illustrates that when the number of photons detected in the multiplexed pulse P is zero and the number of photons detected in the multiplexed pulse Q is one, the signal detection is “success” based on (a) in “rules of signal detection”.

Further, FIG. 8 illustrates that when the number of photons detected in the multiplexed pulse P is zero and the number of photons detected in the multiplexed pulse Q is two or more, the signal detection is “failure” based on 2 of (i) in “rules of signal detection”.

Further, FIG. 8 illustrates that when the number of photons detected in the multiplexed pulse P is one and the number of photons detected in the multiplexed pulse Q is one, the signal detection is “failure” based on 3 of (i) in “rules of signal detection”.

States of the primary light pulse X, the secondary light pulse Y, and the tertiary light pulse Z which enter the reception apparatus 400 are possibly not the same as states of the primary light pulse X, the secondary light pulse Y, and the tertiary light pulse Z which are emitted from the transmission apparatus 300, due to an attack by an eavesdropper on the quantum communication path 101.

Further, when the signal detection is “success”, the reception-side information generation unit 405 generates the reception-side bit value which is each bit value in the reception-side bit string according to following “reception-side bit generation rules”. Further, when the signal detection is “success”, the reception-side information generation unit 405 decides according to following “reception-side bit generation rules”, the multiplexed pulse number j indicating either of the multiplexed pulse P or the multiplexed pulse Q in which the photon has been detected.

### “Reception-Side Bit Generation Rules”

(1) When the photon detection equipment 404a has detected the photon, the reception-side information generation unit 405 generates a reception-side bit value “0”. When the photon detection equipment 404b has detected the photon, the reception-side information generation unit 405 generates a reception-side bit value “1”.
(2) When the photon has been detected in the multiplexed pulse P, the multiplexed pulse number j=1. When the photon has been detected in the multiplexed pulse Q, the multiplexed pulse number j=2.

Then, after transmitting the transmission signal a plurality of times, the reception-side information generation unit 405 generates the reception-side bit string by concatenating in a time-series manner, the reception-side bit values generated using the numbers of photons detected by the photon detection equipment 404a and the photon detection equipment 404b.

Then, the reception-side information generation unit 405 generates the signal reception result 504 with use of the success/failure of the signal detection which has been decided using the number-of-photons detection results 507, and the multiplexed pulse number j, and outputs the signal reception result 504 to the reception-side transmission unit 406.

A specific example of the signal reception result 504 is one of following three types.

“success j=1”

“success j=2”

“failure”

Further, the reception-side information generation unit 405 generates the reception-side error correction information 506 which is information for estimating the bit error rate between the reception-side bit string and the transmission-side bit string, and outputs the reception-side error correction information 506 to the reception-side transmission unit 406.

Further, the reception-side information generation unit 405 acquires from the reception-side information acquisition unit 407, the statistics data D503 and the transmission-side error correction information 505 used for bit error correction which corrects a bit error in the reception-side bit string, and stores these in the storage unit.

Further, the reception-side information generation unit 405 performs the bit error correction, using the transmission-side error correction information 505.

Then, the reception-side information generation unit 405 generates the secret key by performing privacy amplification on the reception-side bit string with use of the statistics data D503 and the reception-side bit string whose error has been corrected.

A specific example of the reception-side error correction information 506 is a bit value which is a part of the reception-side bit string.

The reception-side transmission unit 406 illustrated in FIG. 2 acquires the signal reception result 504 and the reception-side error correction information 506 from the reception-side information generation unit 405 and stores these in the storage unit. Then, the reception-side transmission unit 406 transmits the signal reception result 504 and the reception-side error correction information 506 to the transmission apparatus 300 through the public communication path 102 via the communication interface 430.

The reception-side information acquisition unit 407 illustrated in FIG. 2 acquires from the transmission apparatus 300 through the public communication path 102, the transmission-side error correction information 505 used for the bit error correction which corrects the bit error in the reception-side bit string, and the statistics data D503 which are physical characteristics of the light pulses emitted by the transmission apparatus 300, and stores these in the storage unit. Then, the reception-side information acquisition unit 407 outputs the transmission-side error correction information 505 and the statistics data D503 to the reception-side information generation unit 405.

Note that, in the present embodiment, the reception-side information acquisition unit 407 acquires the statistics data D503 from the transmission apparatus 300, however, not limited to this, the light-source measurement apparatus 200 and the reception apparatus 400 may be connected via the communication path, and the statistics data D503 may be acquired directly from the light-source measurement apparatus 200.

The communication interface 430 illustrated in FIG. 2 executes with the transmission apparatus 300 through the public communication path 102, communication processes of pieces of information regarding the statistics data D503, the signal reception result 504, the transmission-side error correction information 505, and the reception-side error correction information 506.

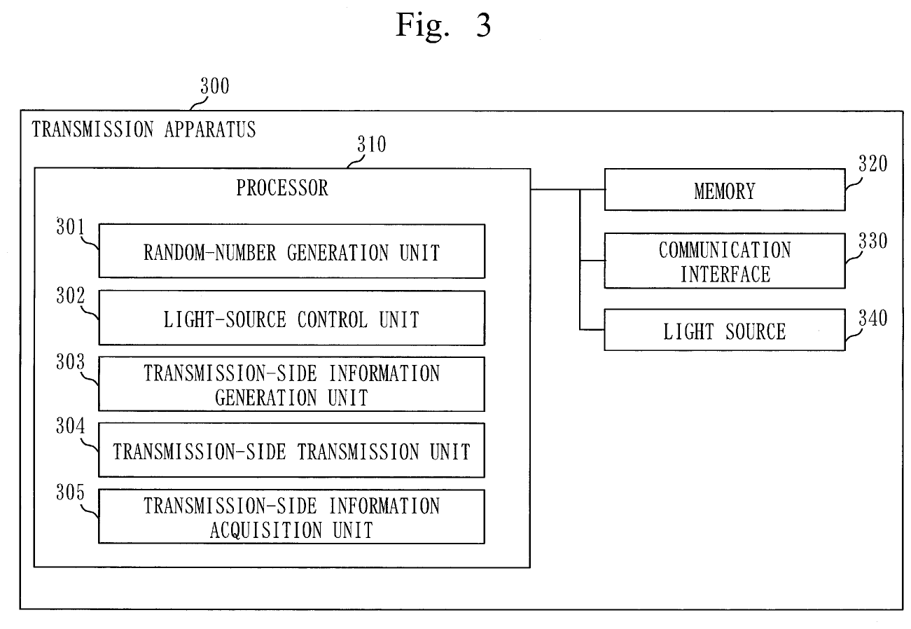

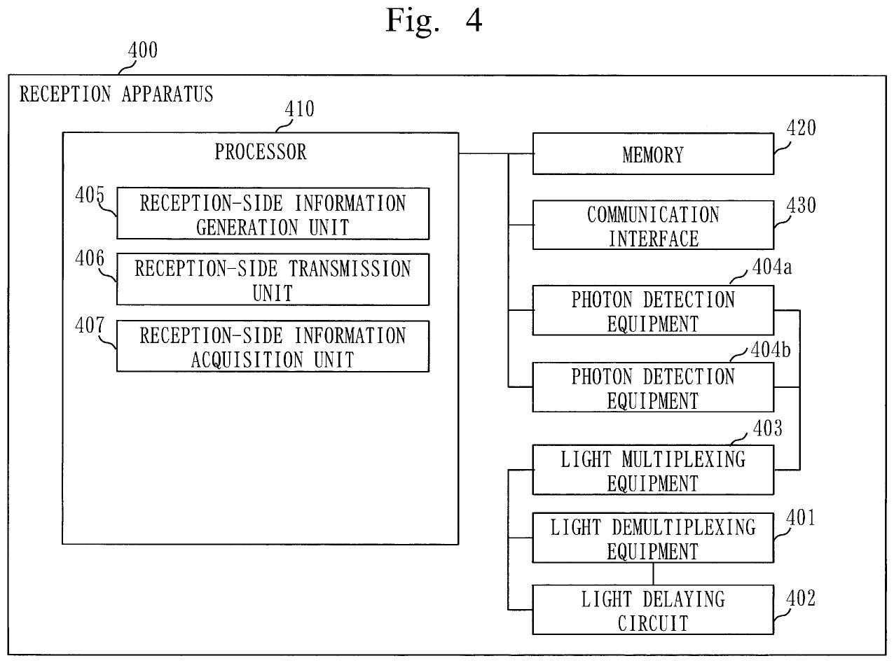

With use of FIGS. 3 and 4, hardware configuration examples of the transmission apparatus 300 and the reception apparatus 400 according to the present embodiment will be described.

FIG. 3 illustrates the hardware configuration example of the transmission apparatus 300 according to the present embodiment.

The transmission apparatus 300 according to the present embodiment is a computer.

The transmission apparatus 300 includes a processor 310, a memory 320, the communication interface 330, and the light source 340 as pieces of hardware, which are connected to each other via a signal line.

The processor 310 is an IC (Integrated Circuit) which performs processing. As a specific example, the processor 310 is a CPU (Central Processing Unit), a DSP (Digital Signal Processor), or the like.

The processor 310 executes a program which realizes operations of the transmission apparatus 300. The program which realizes the operations of the transmission apparatus 300 is a program which realizes functions of the random-number generation unit 301, the light-source control unit 302, the transmission-side information generation unit 303, the transmission-side transmission unit 304, and the transmission-side information acquisition unit 305.

The memory 320 is a storage device. As a specific example, the memory 320 is a RAM (Random Access Memory), a flash memory, or a combination of these.

The memory 320 stores the program which realizes the operations of the transmission apparatus 300.

The communication interface 330 is an electronic circuit which executes a communication process of information with a connection destination via the signal line. The communication interface 330 includes a receiver which receives information input into the transmission apparatus 300 and a transmitter which transmits information output from the transmission apparatus 300. As a specific example, the communication interface 330 is a communication chip or an NIC (Network Interface Card).

The light source 340 emits the light pulses to the quantum communication path 101 corresponding to control by the light-source control unit 302. The light pulses that the light-source control unit 302 causes the light source 340 to emit may be light pulses with any physical characteristics. That is, any kinds of physical characteristics of the light pulses such as a phase and polarization are acceptable.

The program which realizes the operations of the transmission apparatus 300 is read from the memory 320 into the processor 310 and executed by the processor 310.

The memory 320 stores not only the program which realizes the operation of the transmission apparatus 300 but also an OS (Operating System). The processor 310 executes the program which realizes the operations of the transmission apparatus 300 while executing at least a part of the OS. Note that, a part or all of the program which realizes the operations of the transmission apparatus 300 may be incorporated into the OS. By the processor 310 executing the OS, task management, memory management, file management, communication control, and the like are performed.

The program which realizes the operations of the transmission apparatus 300, and the OS may be stored in an auxiliary storage device. As a specific example, the auxiliary storage device is a hard disk, a flash memory, or a combination of these. Further, the auxiliary storage device may be a portable recording medium such as an SSD (registered trademark, Solid State Drive), an SD (registered trademark, Secure Digital) memory card, a CF (registered trademark, CompactFlash), a NAND flash, a flexible disk, an optical disc, a compact disc, a Blu-ray (registered trademark) disc, or a DVD (registered trademark, Digital Versatile Disk), or a combination of these.

When the program which realizes the operations of the transmission apparatus 300, and the OS are stored in the auxiliary storage device, these are loaded from the auxiliary storage device into the memory 320, read from the memory 320 into the processor 310, and executed by the processor 310.

The transmission apparatus 300 may include a plurality of processors which substitute for the processor 310. The plurality of processors share execution of the program which realizes the operations of the transmission apparatus 300. As a specific example, each processor is a CPU.

Data, information, a signal value, and a variable value utilized, processed, or output by the program which realizes the operations of the transmission apparatus 300 are stored in at least one of the memory 320, the auxiliary storage device, and a register and a cash memory in the processor 310.

In the present embodiment, a storage area which is at least one of the memory 320, the auxiliary storage device, and the register and the cash memory in the processor 310 in which the data, the information, the signal value, and the variable value utilized, processed, or output by the program which realizes the operations of the transmission apparatus 300 are stored, is collectively referred to as a storage unit.

The program which realizes the operations of the transmission apparatus 300 may be stored in a computer-readable medium and provided, may be stored in a storage medium and provided, or may be provided as a program product. The program product is not limited to its appearance and is an object into which a computer readable program has been loaded. Further, the program which realizes the operations of the transmission apparatus 300 may be provided via a network.

Note that, in the present embodiment, the random-number generation unit 301 is realized by the processor 310 as software, however, not limited to this, the random-number generation unit 301 may be realized as random-number generation equipment which is hardware.

Further, “unit” of the random-number generation unit 301, the light-source control unit 302, the transmission-side information generation unit 303, the transmission-side transmission unit 304, and the transmission-side information acquisition unit 305 may be read as “circuit”, “step”, “procedure”, or “process”.

Further, the transmission apparatus 300 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

In this case, each of the random-number generation unit 301, the light-source control unit 302, the transmission-side information generation unit 303, the transmission-side transmission unit 304, and the transmission-side information acquisition unit 305 is realized as a part of the processing circuit.

Note that, in the present specification, a superordinate concept of the processor and the processing circuit is referred to as “processing circuitry”.

That is, each of the processor and the processing circuit is a specific example of the “processing circuitry”.

The program which realizes the operations of the transmission apparatus 300 is a program which causes a computer to execute procedures performed by the random-number generation unit 301, the light-source control unit 302, the transmission-side information generation unit 303, the transmission-side transmission unit 304, and the transmission-side information acquisition unit 305 as a random-number generation procedure, a light-source control procedure, a transmission-side information generation procedure, a transmission-side transmission procedure, and a transmission-side information acquisition procedure, respectively.

FIG. 4 illustrates the hardware configuration example of the reception apparatus 400 according to the present embodiment.

The reception apparatus 400 according to the present embodiment is a computer.

The reception apparatus 400 includes the light demultiplexing equipment 401, the light delaying circuit 402, the light multiplexing equipment 403, the photon detection equipment 404a, the photon detection equipment 404b, a processor 410, a memory 420, and the communication interface 430 as pieces of hardware, which are connected to each other via a signal line.

Since details of the light demultiplexing equipment 401, the light delaying circuit 402, the light multiplexing equipment 403, the photon detection equipment 404a, and the photon detection equipment 404b are as described above, descriptions will be omitted.

The light demultiplexing equipment 401, the light delaying circuit 402, the light multiplexing equipment 403, the photon detection equipment 404a, and the photon detection equipment 404b are connected to each other via communication paths which have directivity to deliver the light pulses.

The processor 410 is an IC which performs processing. As a specific example, the processor 410 is a CPU, a DSP, or the like.

The processor 410 executes a program which realizes operations of the reception apparatus 400. The program which realizes the operations of the reception apparatus 400 is a program which realizes functions of the reception-side information generation unit 405, the reception-side transmission unit 406, and the reception-side information acquisition unit 407.

The memory 420 is a storage device. As a specific example, the memory 420 is a RAM, a flash memory, or a combination of these.

The memory 420 stores the program which realizes the operations of the reception apparatus 400.

The communication interface 430 is an electronic circuit which executes a communication process of information with a connection destination via the signal line. The communication interface 430 includes a receiver which receives information input into the reception apparatus 400 and a transmitter which transmits information output from the reception apparatus 400. As a specific example, the communication interface 430 is a communication chip or an NIC.

The program which realizes the operations of the reception apparatus 400 is read from the memory 420 into the processor 410 and executed by the processor 410. The memory 420 stores not only the program which realizes the operation of the reception apparatus 400 but also an OS. The processor 410 executes the program which realizes the operations of the reception apparatus 400 while executing at least a part of the OS. Note that, a part or all of the program which realizes the operations of the reception apparatus 400 may be incorporated into the OS. By the processor 410 executing the OS, task management, memory management, file management, communication control, and the like are performed.

The program which realizes the operations of the reception apparatus 400, and the OS may be stored in an auxiliary storage device. As a specific example, the auxiliary storage device is a hard disk, a flash memory, or a combination of these. Further, the auxiliary storage device may be a portable recording medium such as an SSD (registered trademark), an SD (registered trademark) memory card, a CF (registered trademark), a NAND flash, a flexible disk, an optical disc, a compact disc, a Blu-ray (registered trademark) disc, or a DVD (registered trademark), or a combination of these.

When the program which realizes the operations of the reception apparatus 400, and the OS are stored in the auxiliary storage device, these are loaded from the auxiliary storage device into the memory 420, read from the memory 420 into the processor 410, and executed by the processor 410.

The reception apparatus 400 may include a plurality of processors which substitute for the processor 410. The plurality of processors share execution of the program which realizes the operations of the reception apparatus 400. As a specific example, each processor is a CPU.

Data, information, a signal value, and a variable value utilized, processed, or output by the program which realizes the operations of the reception apparatus 400 are stored in at least one of the memory 420, the auxiliary storage device, and a register and a cash memory in the processor 410.

In the present embodiment, a storage area which is at least one of the memory 420, the auxiliary storage device, and the register and the cash memory in the processor 410 in which the data, the information, the signal value, and the variable value utilized, processed, or output by the program which realizes the operations of the reception apparatus 400 are stored, is collectively referred to as a storage unit.

The program which realizes the operations of the reception apparatus 400 may be stored in a computer-readable medium and provided, may be stored in a storage medium and provided, or may be provided as a program product. The program product is not limited to its appearance and is an object into which a computer readable program has been loaded. Further, the program which realizes the operations of the reception apparatus 400 may be provided via a network.

Further, “unit” of the reception-side information generation unit 405, the reception-side transmission unit 406, and the reception-side information acquisition unit 407 may be read as “circuit”, “step”, “procedure”, or “process”.

Further, “equipment” or “circuit” of the light demultiplexing equipment 401, the light delaying circuit 402, and the light multiplexing equipment 403 may be replaced by “device” or “machine”.

Further, “equipment” of the photon detection equipment 404a and the photon detection equipment 404b may be replaced by “device”, “machine”, or “process”.

Further, the reception apparatus 400 may be realized by a processing circuit. The processing circuit is, for example, a logic IC, a GA, an ASIC, or an FPGA.

In this case, each of the reception-side information generation unit 405, the reception-side transmission unit 406, and the reception-side information acquisition unit 407 is realized as a part of the processing circuit.

The program which realizes the operations of the reception apparatus 400 is a program which causes a computer to execute procedures performed by the reception-side information generation unit 405, the reception-side transmission unit 406, and the reception-side information acquisition unit 407 as a reception-side information generation procedure, a reception-side transmission procedure, and a reception-side information acquisition procedure, respectively.

*** Description of Operation ***

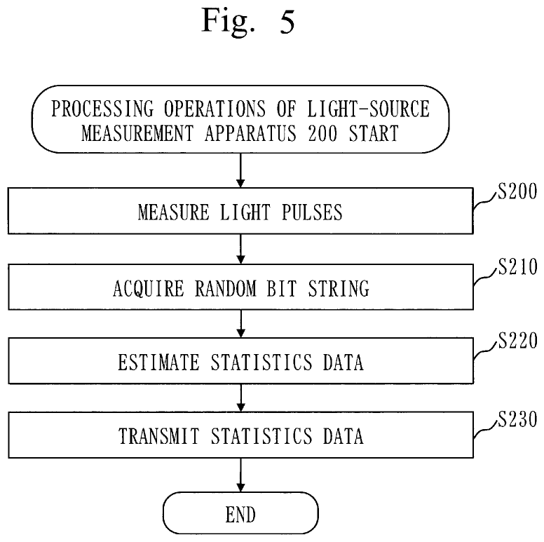

With use of FIGS. 5 to 7, operation examples of quantum-key distribution using the quantum-key distribution system 100 according to the present embodiment will be described.

First, with use of a flowchart of FIG. 5, examples of processing operations of the light-source measurement apparatus 200 according to the present embodiment will be described.

In step S200, the measurement unit 201 measures the three consecutive light pulses that the light-source control unit 302 of the transmission apparatus 300 has caused the light source 340 to emit. Specifically, the measurement unit 201 treats as input, the three consecutive light pulses emitted by the light source 340 and measures as to whether or not the photon exists in the light pulses. Then, the measurement unit 201 stores the number-of-photons-related measurement result 501 in the storage unit and outputs the number-of-photons-related measurement result 501 to the measurement-side information generation unit 202.

Next, in step S210, the measurement-side information acquisition unit 203 acquires from the transmission apparatus 300 through the communication path 103, the random bit string 502 input into the light-source control unit 302 from the random-number generation unit 301 when the light source 340 of the transmission apparatus 300 has emitted the three consecutive light pulses. Then the measurement-side information acquisition unit 203 stores the random bit string 502 in the storage unit. Then, the measurement-side information acquisition unit 203 outputs the random bit string 502 to the measurement-side information generation unit 202.

Next, in step S220, the measurement-side information generation unit 202 acquires the number-of-photons-related measurement result 501 from the measurement unit 201 and the random bit string 502 from the measurement-side information acquisition unit 203, and stores these in the storage unit.

Next, in step S220, the measurement-side information generation unit 202 checks whether or not there are the number-of-photons-related measurement results 501 enough to estimate the statistics data D503 being statistically reliable.

When there are not the number-of-photons-related measurement results 501 enough to estimate the statistics data D503 being statistically reliable, the measurement from step S200 to step S220 will be repeated.

When there are the number-of-photons-related measurement results 501 enough to estimate the statistics data D503 being statistically reliable, the measurement-side information generation unit 202 estimates the statistics data D503 from the number-of-photons-related measurement results 501 and the random bit string 502, and stores the statistics data D503 in the storage unit. More specifically, the measurement-side information generation unit 202 checks the first bit, the second bit, and the third bit in the random bit string 502. Then, the measurement-side information generation unit 202 checks whether or not the photon exists in the primary light pulse X, the secondary light pulse Y, and the tertiary light pulse Z, when a bit value of each bit is “0” or “1”. Then, the measurement-side information generation unit 202 estimates D1 and D2 in the statistics data D503 and stores these in the storage unit.

Further, the measurement-side information generation unit 202 checks whether or not the photon exists in the three consecutive light pulses. Then, the measurement-side information generation unit 202 estimates D3, D4, and D5 in the statistics data D503 and stores these in the storage unit.

Then, the measurement-side information generation unit 202 outputs the statistics data D503 to the transmission-side transmission unit 304.

Next, in step S230, the measurement-side transmission unit 204 acquires the statistics data D503 from the measurement-side information generation unit 202 and stores the statistics data D503 in the storage unit. Then, the measurement-side transmission unit 204 transmits the statistics data D503 to the transmission apparatus 300 through the communication path 103 via the communication interface 205.

Note that, the measurement from step S200 to step S230 is implemented in advance before the quantum-key distribution is performed.

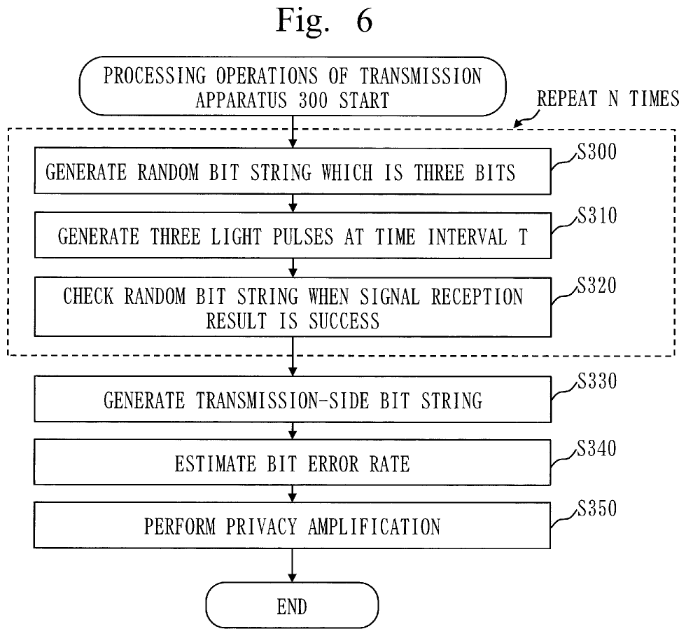

Next, with use of a flowchart of FIG. 6, examples of the processing operations of the transmission apparatus 300 according to the present embodiment will be described.

In step S300, the random-number generation unit 301 generates random bits each of which is 0 or 1 selected randomly and generates the random bit string 502 which is three bits. Then, the random bit string 502 generated by the random-number generation unit 301 is output to the light-source control unit 302 and the transmission-side information generation unit 303.

Next, in step S310, the light-source control unit 302 acquires the random bit string 502 from the random-number generation unit 301 and stores the random bit string 502 in the storage unit. Then, with use of the light source 340, based on the random bit string 502, the light-source control unit 302 generates as one light pulse string, three light pulses in which the primary light pulse X, the secondary light pulse Y, and the tertiary light pulse Z are arranged consecutively at the time interval T. Then, the light source 340 transmits the three consecutive light pulses to the reception apparatus 400 through the quantum communication path 101.

Next, in step S320, the transmission-side information acquisition unit 305 acquires the signal reception result 504 of the transmission signal transmitted from the reception apparatus 400 in step S310, and stores the signal reception result 504 in the storage unit. The signal reception result 504 is configured with the success/failure of the signal detection, and the multiplexed pulse number j when the signal detection is “success”. Then, the transmission-side information acquisition unit 305 outputs the signal reception result 504 to the transmission-side information generation unit 303. Then, the transmission-side information generation unit 303 acquires the signal reception result 504 from the transmission-side information acquisition unit 305 and stores the signal reception result 504 in the storage unit. Further, the transmission-side information generation unit 303 acquires the random bit string 502 from the random-number generation unit 301 and stores the random bit string 502 in the storage unit.

Then, the transmission-side information generation unit 303 generates the transmission-side bit value from the random bit string 502, using the signal reception result 504. More specifically, the transmission-side information generation unit 303 refers to the multiplexed pulse number j when the signal detection of the signal reception result 504 is “success”. In a case of j=1, the transmission-side information generation unit 303 inspects the first bit value corresponding to the primary light pulse X and the second bit value corresponding to the secondary light pulse Y in the random bit string 502. Then, when the first bit value and the second bit value are the same values, the transmission-side information generation unit 303 generates the transmission-side bit value “0” based on “generation rules of a transmission-side bit string”. On the other hand, when the first bit value and the second bit value are not the same values, the transmission-side information generation unit 303 generates the transmission-side bit value “1” based on “generation rules of a transmission-side bit string”.

That is, in the case of j=1,

when (the first bit value in the random bit string 502, the second bit value in the random bit string 502)=(0, 0) or (1, 1), the transmission-side bit value=0.

On the other hand, in the case of j=1,

when (the first bit value in the random bit string 502, the second bit value in the random bit string 502)=(0, 1) or (1, 0), the transmission-side bit value=1.

Further, the transmission-side information generation unit 303 refers to the multiplexed pulse number j when the signal detection of the signal reception result 504 is “success”. In a case of j=2, the transmission-side information generation unit 303 inspects the second bit value corresponding to the secondary light pulse Y and the third bit value corresponding to the tertiary light pulse Z in the random bit string 502. Then, when the second bit value and the third bit value are the same values, the transmission-side information generation unit 303 generates the transmission-side bit value “1” based on “generation rules of a transmission-side bit string”. On the other hand, when the second bit value and the third bit value are not the same values, the transmission-side information generation unit 303 generates the transmission-side bit value “1” based on “generation rules of a transmission-side bit string”.

That is, in the case of j=2,

When (the second bit value in the random bit string 502, the third bit value in the random bit string 502)=(0, 0) or (1, 1), the transmission-side bit value=0.

On the other hand, in the case of j=2,

When (the second bit value in the random bit string 502, the third bit value in the random bit string 502)=(0, 1) or (1, 0), the transmission-side bit value=1.

Below, with use of a specific example, an example will be described in which the reception-side information generation unit 405 generates the reception side bit value “0” and the transmission-side information generation unit 303 generates the transmission-side bit value “0”, for one transmission of the transmission signal.

As a specific example, it is assumed that the primary light pulse X, the secondary light pulse Y, and the tertiary light pulse Z are emitted as the three consecutive light pulses corresponding to the random bit string 502 “001”. Then, it is assumed that the light pulses each corresponding to each bit value in the random bit string 502 are plane waves having the same strength and the same pulse width. Further, it is assumed that a phase difference between the light pulse corresponding to the bit value “0” and the light pulse corresponding to the bit value “1” is π. That is, the primary light pulse X and the secondary light pulse Y are plane waves having the same strength, the same phases, and the same pulse width. Further, the tertiary light pulse Z is a plane wave having the same strength and the same pulse width as the primary light pulse X and the secondary light pulse Y and having a phase shifted by n from the primary light pulse X and the secondary light pulse Y.

When such light pulses are emitted, the multiplexed pulse 510 which enters the photon detection equipment 404a includes the multiplexed pulse P whose strength has been strengthened by superimposition of the secondary light pulse Y of the first light pulse 508 and the primary light pulse X of the second light pulse 509 at the same phase. Further, the multiplexed pulse 510 which enters the photon detection equipment 404a includes the multiplexed pulse Q in which the tertiary light pulse Z of the first light pulse 508 and the secondary light pulse Y of the second light pulse 509 have canceled each other out by being superposed at the opposed phase.

On the other hand, the multiplexed pulse 510 which enters the photon detection equipment 404b includes the multiplexed pulse P in which the secondary light pulse Y of the first light pulse 508 and the primary light pulse X of the second light pulse 509 have canceled each other out by being superposed at the opposed phase. Further, the multiplexed pulse 510 which enters the photon detection equipment 404b includes the multiplexed pulse Q whose strength has been strengthened by superimposition of the tertiary light pulse Z of the first light pulse 508 and the secondary light pulse Y of the second light pulse 509 at the same phase.

That is, when the random bit string 502 has the same values in the first bit value and the second bit value of the random bits like “001”, the strength of the multiplexed pulse P included in the multiplexed pulse 510 which enters the photon detection equipment 404a increases and the strength of the multiplexed pulse Q included therein decreases. Therefore, in the photon detection equipment 404a, a probability that the photon is detected in the multiplexed pulse P increases and a probability that the photon is detected in the multiplexed pulse Q decreases. Note that, when the quantum communication path 101, the light demultiplexing equipment 401, the light delaying circuit 402, and the light multiplexing equipment 403 are in ideal states where loss or dispersion does not occur, and the photon detection equipment 404a is in an ideal state where a dark detection rate (also referred to as a dark count rate) is zero, the probability that the photon detection equipment 404a detects the photon in the multiplexed pulse Q is zero.

Further, when the random bit string 502 does not have the same values in the second bit value and the third bit value of the random bits like “001”, the strength of the multiplexed pulse Q included in the multiplexed pulse 510 which enters the photon detection equipment 404b increases and the strength of the multiplexed pulse P included therein decreases. Therefore, in the photon detection equipment 404b, a probability that the photon is detected in the multiplexed pulse Q increases and a probability that the photon is detected in the multiplexed pulse P decreases. Note that, when the quantum communication path 101, the light demultiplexing equipment 401, the light delaying circuit 402, and the light multiplexing equipment 403 are in ideal states where loss or dispersion does not occur, and the photon detection equipment 404b is in an ideal state where a dark detection rate (also referred to as a dark count rate) is zero, the probability that the photon detection equipment 404b detects the photon in the multiplexed pulse P is zero.

If one photon has been detected in the multiplexed pulse P by the photon detection equipment 404a, no photon has been detected in the multiplexed pulse P by the photon detection equipment 404b, and no photon has been detected in the multiplexed pulse Q by the photon detection equipment 404a and the photon detection equipment 404b, the signal detection is “success” in the reception apparatus 400 based on “rules of signal detection”. Then, the reception-side bit value “0” is generated in the reception apparatus 400 based on “reception-side bit generation rules”. Further, since the signal detection is “success” and the photon has been detected in the multiplexed pulse P by the reception apparatus 400, the signal reception result 504 of the multiplexed pulse number j=1 is generated and transmitted to the transmission apparatus 300 through the public communication path 102.

When the transmission apparatus 300 acquires the signal reception result 504 including the multiplexed pulse number j=1 from the reception apparatus 400, the transmission-side information generation unit 303 inspects the first bit value and the second bit value in the random bit string 502 since the multiplexed pulse number j is 1. Since the random bit string 502 in the present example is “001”, and the first bit value and the second bit value are the same values, the transmission-side information generation unit 303 generates the transmission-side bit value “0”. In this way, the reception-side bit value and the transmission-side bit value are “0” and the same.

If one photon has been detected in the multiplexed pulse Q by the photon detection equipment 404b, no photon has been detected in the multiplexed pulse Q by the photon detection equipment 404a, and no photon has been detected in the multiplexed pulse P by the photon detection equipment 404a and the photon detection equipment 404b, the signal detection is “success” in the reception apparatus 400 based on “rules of signal detection”. Then, the reception-side bit value “1” is generated in the reception apparatus 400 based on “reception-side bit generation rules”. Further, since the signal detection is “success” and the photon has been detected in the multiplexed pulse Q by the reception apparatus 400, the signal reception result 504 of the multiplexed pulse number j=2 is generated and transmitted to the transmission apparatus 300 through the public communication path 102.

When the transmission apparatus 300 acquires the signal reception result 504 including the multiplexed pulse number j=2 from the reception apparatus 400, the transmission-side information generation unit 303 inspects the second bit value and the third bit value in the random bit string 502 since the multiplexed pulse number j is two. Since the random bit string 502 in the present example is “001”, and the second bit value and the third bit value are not the same values, the transmission-side information generation unit 303 generates the transmission-side bit value “1”. That is, the receptions-side bit value and the transmission-side bit value are “1” and the same.

As described above, the transmission apparatus 300 receives the success/failure of the signal detection and the multiplexed pulse number j as the signal reception result 504 from the reception apparatus 400, and as a result, the transmission apparatus 300 can estimate the reception-side bit value generated by the reception apparatus 400.

The above-described processes from step S300 to step S320 are repeatedly executed N times.

After the above-described processes from step S300 to step S320 are repeatedly executed N times, the signal detection for N times of transmission of the transmission signal is “success”, and the number of times that the signal has been detected by the reception apparatus 400 is set to be M.

After N times of transmission of the transmission signal, in step S330, the transmission-side information generation unit 303 generates the transmission-side bit string by concatenating in a time-series manner, the transmission-side bit values generated in step S320. Since the transmission-side bit values are generated when the signal detection is “success”, length of the transmission-side bit string is M.

Note that, since the transmission-side bit string is secret information, the transmission-side bit string needs to be stored stringently so that the transmission-side bit string does not leak to the outside of the transmission apparatus 300.

Next, in step S340, the transmission-side information acquisition unit 305 acquires the reception-side error correction information 506 which is information for estimating the bit error rate between the reception-side bit string and the transmission-side bit string, from the reception apparatus 400 through the public communication path 102 via the communication interface 330, and stores the reception-side error correction information 506 in the storage unit.

Then, the transmission-side information acquisition unit 305 outputs the reception-side error correction information 506 to the transmission-side information generation unit 303.

Then, the transmission-side information generation unit 303 acquires the reception-side error correction information 506 from the transmission-side information acquisition unit 305, stores the reception-side error correction information 506 in the storage unit, and estimates the bit error rate, using the reception-side error correction information 506. More specifically, the transmission-side information generation unit 303 estimates the bit error rate between the reception-side bit string and the transmission-side bit string, using the reception-side error correction information 506. The estimation result is written as E.

Then, the transmission-side information generation unit 303 generates with use of the transmission-side bit string, the transmission-side error correction information 505 used for the bit error correction which corrects the bit error in the reception-side bit string in the reception apparatus 400, and outputs the transmission-side error correction information 505 to the transmission-side transmission unit 304.

Further, the transmission-side information acquisition unit 305 acquires the statistics data D503 from the light-source measurement apparatus 200 through the public communication path 102 via the communication interface 330, stores the statistics data D503 in the storage unit, and outputs the statistics data D503 to the transmission-side information generation unit 303.

Then, the transmission-side information generation unit 303 acquires the statistics data D503 from the transmission-side information acquisition unit 305, stores the statistics data D503 in the storage unit, and outputs the statistics data D503 to the transmission-side transmission unit 304.

Then, the transmission-side transmission unit 304 acquires the transmission-side error correction information 505 and the statistics data D503 from the transmission-side information generation unit 303 and stores these in the storage unit. Then, the transmission-side transmission unit 304 transmits the transmission-side error correction information 505 and the statistics data D503 to the reception apparatus 400 through the public communication path 102 via the communication interface 330.

When the transmission-side information generation unit 303 generates the transmission-side error correction information 505, the transmission-side information generation unit 303 deletes the transmission-side bit string used for generating the transmission-side error correction information 505 and shortens the transmission-side bit string. As a specific example of shortening, the transmission-side information generation unit 303 deletes the transmission-side bit string used for generating the syndrome of the LDPC code and shortens the transmission-side bit string.

Below, length of the bits deleted in the generation of the transmission-side error correction information 505 by the transmission-side information generation unit 303 is written as A. That is, length of the transmission-side bit string after the transmission-side error correction information 505 is generated is (M-A).

Next, in step S350, the transmission-side information generation unit 303 performs the privacy amplification on the transmission-side bit string, using the statistics data D503 and the estimation result E of the bit error rate.

The privacy amplification in the present embodiment is a process of shortening with use of a formula 1, the length of the transmission-side bit string by F(E, D) which is an amount of a bit value that has been possibly eavesdropped.

$$F ( E , D ) = M \times h [ ( 3 + \sqrt{5} ) E + \frac{N}{M} \{ ( 3 + \sqrt{5} ) \sqrt{ab} + c \} ] \qquad [ formula 1 ]$$

Note that, h in the formula 1 is a binary entropy function and is indicated in a formula 2.

h(x)=−x log₂x−(1−x)log₂(1−x) [formula 2]

Further, a, b, and c in the formula 1 are indicated as a=PD3+3t, b=PD5+t³+6t²+3t, and c=PD4+t³+9t²+6t respectively, with use oft in a formula 3 and (1) to (5) included in the statistics data D503.

t=max{(\sqrt{PD1U}−\sqrt{PD2L})²,(\sqrt{PD1U}−\sqrt{PD2L})²}/4 [formula 3]

F(E, D) is a function derived from security proof which proves security of the secret key to be generated by the transmission apparatus and the reception apparatus when the light signal transmitted by the transmission apparatus in the quantum-key distribution system is the three consecutive light pulses.

F(E, D) is a function for calculating an upper limit of a bit amount that has been possibly eavesdropped by an eavesdropper. That is, the transmission-side information generation unit 303 can shorten the transmission-side bit string by a bit amount equivalent to the upper limit of the bit amount which has been possibly eavesdropped, with use of F(E, D).

If the amount of signal eavesdropped by the eavesdropper on the quantum communication path 101 increases, the estimation result E of the bit error rate increases. Then, when E increases, F(E, D) increases. That is, if the amount of signal eavesdropped by the eavesdropper increases, the transmission-side information generation unit 303 shortens the transmission-side bit string, using the correspondingly increased F(E, D).

A specific example of a shortening method is a method in which the transmission-side information generation unit 303 multiplies a string vector having (M-A) rows and one column by a matrix having (M-A-F(E, D)) rows and (M-A) columns from a left side of the string vector, where the string vector is composed of the transmission-side bit string after the bit error correction and each of components of the matrix is randomly selected “0” or “1”. By this computation, the transmission-side information generation unit 303 can shorten the string vector to a string vector having a (M-A-F(E, D)) rows and one column, in which the bit amount of F(E, D) has been removed.

Then, the transmission-side information generation unit 303 generates a secret key of bits of length of (M-A-F(E, D)).

As described above, the transmission-side information generation unit 303 can exclude the bit value equivalent to the bit amount that has been possibly eavesdropped in a process of the quantum-key distribution, by performing the privacy amplification, and generate the secure secret key based on the security proof of the quantum-key distribution according to the present embodiment.

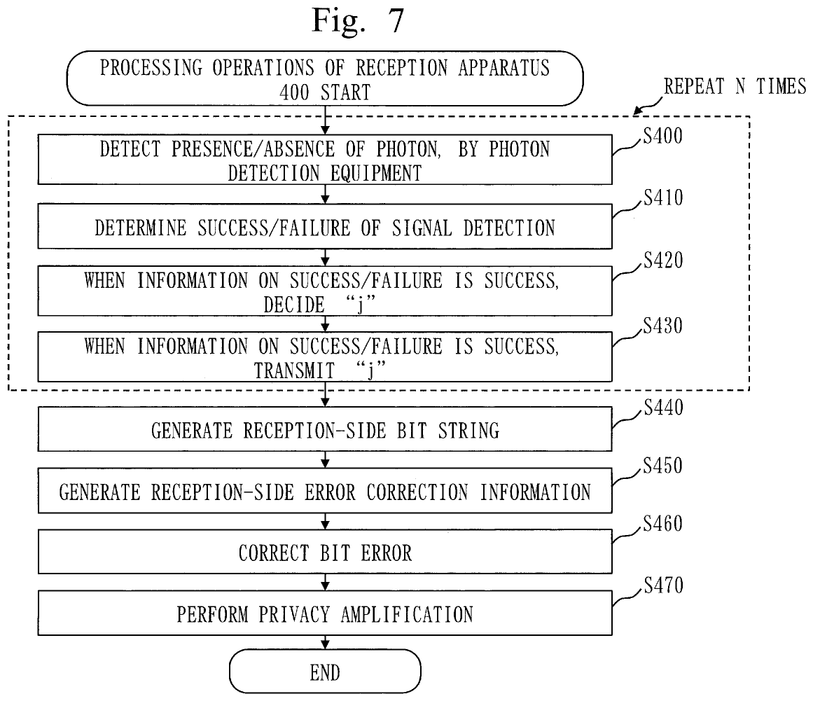

Next, with use of a flowchart of FIG. 7, examples of processing operations of the reception apparatus 400 according to the present embodiment will be described.

In step S400, the photon detection equipment 404a and the photon detection equipment 404b detect the numbers of photons in the multiplexed pulses 510, identifying which of zero, one, or two or more the numbers of photons existing in the multiplexed pulses 510 which have entered from the light multiplexing equipment 403 are. Then, the photon detection equipment 404a and the photon detection equipment 404b output the number-of-photons detection results 507 to the reception-side information generation unit 405.

Next, in step S410, the reception-side information generation unit 405 acquires the number-of-photons detection results 507 from the photon detection equipment 404a and the photon detection equipment 404b and stores the number-of-photons detection results 507 in the storage unit.

Then, the reception-side information generation unit 405 decides the success/failure of the signal detection according to (a) and (i) in above-described “rules of signal detection”.

Next, in step S420, when the signal detection is “success”, the reception-side information generation unit 405 generates the reception-side bit value of “0” or “1” according to above-described “reception-side bit generation rules”. Further, when the signal detection is “success”, the reception-side information generation unit 405 decides the multiplexed pulse number j according to “reception-side bit generation rules”. Then, the reception-side information generation unit 405 outputs to the receptions-side transmission unit 406, the success/failure of the signal detection and the multiplexed pulse number j as the signal reception result 504.

Next, in step S430, the reception-side transmission unit 406 acquires the signal reception result 504 from the reception-side information generation unit 405 and stores the signal reception result 504 in the storage unit. Then, the reception-side transmission unit 406 transmits the signal reception result 504 to the transmission apparatus 300 through the public communication path 102 via the communication interface 430.

The above-described processes from step S400 to step S430 are repeatedly executed N times.

After the above-described processes from step S400 to step S430 are repeatedly executed N times, the success/failure of the signal detection for N times of transmission of the transmission signal is “success”, and the number of times that the signal has been detected in the reception apparatus 400 is set to be M.

After N times of transmission of the transmission signal, in step S440, the reception-side information generation unit 405 generates the reception-side bit string by concatenating in a time-series manner, the reception-side bit values generated in step S420. Since the reception-side bit values are generated when the success/failure of the signal detection is “success”, length of the reception-side bit string is M.

Note that, since the reception-side bit string is secret information, the reception-side bit string needs to be stored stringently so that the reception-side bit string does not leak to the outside of the reception apparatus 400.

Next, in step S450, the reception-side information generation unit 405 generates the reception-side error correction information 506, using the reception-side bit string and outputs the reception-side error correction information 506 to the reception-side transmission unit 406. Then, the reception-side transmission unit 406 acquires the reception-side error correction information 506 from the reception-side information generation unit 405 and stores the reception-side error correction information 506 in the storage unit. Then, the reception-side transmission unit 406 transmits the reception-side error correction information 506 to the transmission apparatus 300 through the public communication path 102 via the communication interface 430.

Next, in step S460, the reception-side information acquisition unit 407 acquires the transmission-side error correction information 505 used for the bit error correction which corrects the bit error in the reception-side bit string, from the transmission apparatus 300 through the public communication path 102 via the communication interface 430, and stores the transmission-side error correction information 505 in the storage unit. Then, the reception-side information acquisition unit 407 outputs the transmission-side error correction information 505 to the reception-side information generation unit 405.

Then, the reception-side information generation unit 405 acquires the transmission-side error correction information 505 from the reception-side information acquisition unit 407 and stores the transmission-side error correction information 505 in the storage unit.

Then, the reception-side information generation unit 405 performs the bit error correction on the reception-side bit string, using the transmission-side error correction information 505.

Length of a bit lost in the bit error correction is A which is the same as that of step S340 in FIG. 6. That is, the length of the reception-side bit string after performing the bit error correction is (M-A).

If the bit error correction succeeds, the transmission-side bit string and the reception-side bit string become the same.

Next, in step S470, the reception-side information acquisition unit 407 acquires the statistics data D503 from the transmission apparatus 300 through the public communication path 102 via the communication interface 430 and stores the statistics data D503 in the storage unit. Then, the reception-side information acquisition unit 407 outputs the statistics data D503 to the reception-side information generation unit 405.

Then, the reception-side information generation unit 405 acquires the statistics data D503 from the reception-side information acquisition unit 407, stores the statistics data D503 in the storage unit, and performs the privacy amplification on the reception-side bit string, using the statistics data D503. Since the privacy amplification is the same method as that of the transmission apparatus 300 as described above, descriptions thereof will be omitted.

Then, the reception-side information generation unit 405 generates a secret key of bits of length of (M-A-F(E, D)).

In this way, the reception-side information generation unit 405 can remove the bit value equivalent to the bit amount that has been possibly eavesdropped in a process of the quantum-key distribution, by performing the privacy amplification, and generate the secure secret key based on the security proof of the quantum-key distribution according to the present embodiment.

*** Description of Effect of Embodiment ***

As described above, in the present embodiment, the light pulses emitted by the transmission apparatus are measured, using the light-source measurement apparatus. Then, the quantum-key distribution is performed which generates the secret key common between the transmission apparatus and the reception apparatus based on the security proof of the quantum-key distribution which uses the statistics data which are the number-of-photons statistics regarding the zero photon, the one photon, the two photons, and the three photons estimated from the measurement results. A physical characteristic of the transmission apparatus enough for the security proof is only the number-of-photons statistics regarding the zero photon, the one photon, the two photons, and the three photons, which is estimated by the light-source measurement apparatus and acquired by the transmission-side information acquisition unit of the transmission apparatus. Therefore, types of light pulses the transmission apparatus emits may be unknown in advance, and an effect is obtained of being able to realize the quantum-key distribution which generates the secure secret key between the transmission apparatus and the reception apparatus without requiring the physical characteristics such as polarization and a phase of the light pulses emitted by the transmission apparatus.

### First Modification Example

In the first embodiment, an example has been described in which the transmission apparatus 300 acquires the statistics data D503 from the light-source measurement apparatus 200 and stores the statistics data D503 in the storage unit in the process of step S340 in FIG. 6. However, not limited to this, the transmission apparatus 300 may acquire the statistics data D503 from the light-source measurement apparatus 200 at any time before the privacy amplification is performed in the process of step S350 in FIG. 6.

### Second Modification Example

In the first embodiment, an example has been described in which the reception apparatus 400 acquires the statistics data D503 from the transmission apparatus 300 and stores the statistics data D503 in the storage unit in the process of step S470 in FIG. 7. However, not limited to this, the reception apparatus 400 may acquire the statistics data D503 from the transmission apparatus 300 at any time before the privacy amplification is performed in the process of step S470 in FIG. 7.

Above, although the embodiment according to the present disclosure has been described, the embodiment may be implemented partially.

Note that, the present disclosure is not limited to the embodiment, and various modifications can be made as necessary.

### REFERENCE SIGNS LIST

100: quantum-key distribution system, 101: quantum communication path, 102: public communication path, 103: communication path, 200: light-source measurement apparatus, 201: measurement unit, 202: measurement-side information generation unit, 203: measurement-side information acquisition unit, 204: measurement-side transmission unit, 205: communication interface, 300: transmission apparatus, 301: random-number generation unit, 302: light-source control unit, 303: transmission-side information generation unit, 304: transmission-side transmission unit, 305: transmission-side information acquisition unit, 310: processor, 320: memory, 330: communication interface, 340: light source, 400: reception apparatus, 401: light demultiplexing equipment, 402: light delaying circuit, 403: light multiplexing equipment, 404a: photon detection equipment, 404b: photon detection equipment, 405: reception-side information generation unit, 406: reception-side transmission unit, 407: reception-side information acquisition unit, 410: processor, 420: memory, 430: communication interface, 501: number-of-photons-related measurement result, 502: random bit string, 503: statistics data D, 504: signal reception result, 505: transmission-side error correction information, 506: reception-side error correction information, 507: number-of-photons detection result, 508: first light pulse, 509: second light pulse, 510: multiplexed pulse.

1. A transmission apparatus comprising:
processing circuitry
to generate a random bit string;
to generate as transmission signal, using a light source, light pulses each of which corresponds to each bit value in the random bit string generated, and emit the light pulses to a reception apparatus;
to acquire from a light-source measurement apparatus which has measured the light pulses and has estimated a physical characteristic, the physical characteristic, and acquire from the reception apparatus, a signal reception result of the transmission signal; and
to generate a secret key, using the random bit string, the physical characteristic and the signal reception result.

2. The transmission apparatus according to claim 1, wherein
the processing circuitry receives as the physical characteristic, number-of-photons statistics regarding zero photon, one photon, two photons, and three photons in the light pulses.

3. The transmission apparatus according to claim 2, wherein
the processing circuitry generates a transmission-side bit string, using the signal reception result and the random bit string, and generates the secret key by performing privacy amplification on the transmission-side bit string, using the physical characteristic.

4. The transmission apparatus according to claim 3, wherein
the processing circuitry
acquires from the reception apparatus, reception-side error correction information which is information for estimating a bit error rate between a reception-side bit string generated by the reception apparatus and the transmission-side bit string, and
estimates the bit error rate, using the reception-side error correction information.

5. The transmission apparatus according to claim 1, wherein
the processing circuitry generates three consecutive light pulses as a block of light pulse string, using the light source, and emits the light pulse string to the reception apparatus.

6. A reception apparatus comprising:
photon detection equipment to detect the number of photons in a multiplexed pulse synthesized from light pulses which have entered from a transmission apparatus; and
processing circuitry
to acquire from a light-source measurement apparatus which has measured the light pulses and has estimated a physical characteristic, the physical characteristic, and
to generate a signal reception result, using the number of photons detected by the photon detection equipment, and generate a secret key, using the physical characteristic.

7. The reception apparatus according to claim 6, wherein
the processing circuitry receives as the physical characteristic, number-of-photons statistics regarding zero photon, one photon, two photons, and three photons in the light pulses.

8. The reception apparatus according to claim 7 further comprising:
light demultiplexing equipment; a light delaying circuit; and light multiplexing equipment, and wherein
the light demultiplexing equipment demultiplexes the light pulses which have entered, into a first light pulse and a second light pulse, and
the light delaying circuit delays delivery of the second light pulse, and
the light multiplexing equipment generates the multiplexed pulse by multiplexing the first light pulse and the second light pulse which has been delayed by the light delaying circuit.

9. The reception apparatus according to claim 7, wherein
the processing circuitry generates a reception-side bit string, using the number of photons detected by the photon detection equipment, and generates the secret key by performing privacy amplification on the reception-side bit string, using the physical characteristic acquired.

10. The reception apparatus according to claim 8, wherein
the processing circuitry
acquires from the transmission apparatus, transmission-side error correction information used for bit error correction which corrects a bit error in the reception-side bit string, and
performs the bit error correction, using the transmission-side error correction information.

11. The reception apparatus according to claim 6, wherein
the photon detection equipment detects the number of photons, identifying which of zero, one, or two or more the number of photons is.

12. A quantum-key distribution system comprising:
the transmission apparatus according to claim 1;
the reception apparatus according to claim 6; and
a light-source measurement apparatus, and wherein
the reception apparatus comprises processing circuitry to transmit the signal reception result, and
the light-source measurement apparatus comprises
processing circuitry
to measure light pulses and estimate as a physical characteristic, number-of-photons statistics regarding zero photon, one photon, two photons, and three photons in the light pulses, and
to transmit the physical characteristic estimated.

13. A transmission method comprising:
generating a random bit string;
generating as transmission signal, using a light source, light pulses each of which corresponds to each bit value in the random bit string generated, and emitting the light pulses to a reception apparatus;
acquiring from a light-source measurement apparatus which has estimated a physical characteristic of the light pulse, the physical characteristic, and acquiring from the reception apparatus, a signal reception result of the transmission signal; and
generating a secret key, using the random bit string, the physical characteristic, and the signal reception result.

14. A reception method comprising:
detecting the number of photons in a multiplexed pulse synthesized from light pulses which have entered from a transmission apparatus;
acquiring from a light-source measurement apparatus which has estimated a physical characteristic of the light pulse, the physical characteristic; and
generating a signal reception result, using the number of photons detected by the photon detection equipment, and generating a secret key, using the physical characteristic and the number of photons.

15. A non-transitory computer readable medium storing a transmission program which causes a computer to execute:
a random-number generation process of generating a random bit string;
a light-source control process of generating as transmission signal, using a light source, light pulses each of which corresponds to each bit value in the random bit string, and emitting the light pulses to a reception apparatus;
a transmission-side information acquisition process of acquiring from a light-source measurement apparatus which has measured the light pulses and has estimated a physical characteristic, the physical characteristic, and acquiring from the reception apparatus, a signal reception result of the transmission signal; and
a transmission-side information generation process of generating a secret key, using the random bit string, the physical characteristic, and the signal reception result.

16. A non-transitory computer readable medium storing a reception program which causes a computer to execute:
a photon detection process of detecting the number of photons in a multiplexed pulse synthesized from light pulses which have entered from a transmission apparatus;
a reception-side information acquisition process of acquiring from a light-source measurement apparatus which has measured the light pulses and has estimated a physical characteristic, the physical characteristic; and
a reception-side information generation process of generating a signal reception result, using the number of photons detected by the photon detection equipment, and generating a secret key, using the physical characteristic and the number of photons.
